(19) United States
(12) Patent Application Publication
(10) Pub. No.: US 2004/0090343 A1
(43) Pub. Date: May 13, 2004

(54) Interchangeable frame for a display cluster

(75) Inventors: Shannon Cassell, Palm Bay, FL (US); Tom Bucaccio, Grant, FL (US)

Correspondence Address: PILLSBURY WINTHROP, LLP, P.O. BOX 10500, MCLEAN, VA, 22102, US

(73) Assignee: Bombardier Motor Corporation of America, Grant, FL

(21) Appl. No.: 10/616,993

(22) Filed: Jul. 11, 2003

Related U.S. Application Data
(60) Provisional application No. 60/394,880, filed on Jul. 11, 2002.

(51) Int. Cl. G08B 5/24; G09F 9/00

(52) U.S. Cl. 340/815.78; 116/284

(57) ABSTRACT

A display device is provided for use, for example, on a vehicle. The display device has a removable frame that is snap fit onto the display cluster housing. The frame can be interchangeable with frames having different aesthetic attributes. Removal of the frame does not affect the water resistance of the display device.

This application claims the benefit of priority to U.S. Provisional Patent Application No. 60/394,880 titled “INTERCHANGEABLE FRAME FOR A DISPLAY CLUSTER”, filed on Jul. 11, 2002, which is incorporated herein by reference.

### BACKGROUND

1. Field of the Invention

This invention relates to display devices, especially for vehicles. In particular, this invention relates to display devices and frames for finishing the edges of display devices.

2. Discussion of Related Art

Prior art display devices used on vehicles, particularly watercraft, are typically sealed units that are installed on the vehicle in one piece. As such, the appearance of the display unit cannot be changed. This limits the design aesthetics available to the vehicle manufacturer.

To vary the appearance of the display device, typically a manufacturer would have to produce entirely different display devices for installation on different models, for example, that have different aesthetic design schemes. This is costly for the manufacturer.

Thus, there is a need for a versatile display device that can adapt to different design schemes and offer aesthetic alternatives.

### SUMMARY OF THE INVENTION

An aspect of the invention is to provide a frame for a display device that is removable and interchangeable with frames having different aesthetic attributes.

Another aspect of the invention is to provide a frame for a display device that removes easily from the display casing.

A further aspect of the invention is to provide a display device having interchangeable parts, which reduces manufacturing cost.

The invention is directed to a display device, comprising a casing, at least one gauge disposed in the casing, a connector port supported by the casing and connected to the at least one gauge, a window on the casing over the at least one gauge, and a frame removably attached to the casing.

The invention is also directed to a vehicle having a display device, comprising a vehicle body, an operator seat carried on the body, an engine supported by the body configured for driving the vehicle, an electronic control unit connected to the engine, and a display device connected to the electronic control unit and positioned within visual proximity to the operator seat. The display device includes at least one gauge that displays a sensed condition of the vehicle, a casing that houses the at least one gauge, a window on the casing over the gauge, and a display frame removably coupled to the casing.

The invention is additionally directed to a frame for use on a display device, comprising an annular member formed of plastic and having a generally L-shaped cross sectional configuration with two legs. Each leg has at least one hook formed thereon for engaging an edge of a self contained display device.

These aspects and other features of the invention will become apparent from the following detailed description and drawings, which disclose preferred embodiments of the invention.

### BRIEF DESCRIPTION OF THE DRAWINGS

Referring to the figures:

FIG. 1 is an exploded perspective view of the display device in accordance with this invention showing the display cluster housing and removable frame;

FIG. 2 is a front view of the display device in accordance with a preferred embodiment of the invention;

FIG. 3 is a rear view of the display device of FIG. 2;

FIG. 4 is a top view of the display device of FIG. 2;

FIG. 5 is bottom cross sectional view of the display device taken along line CC of FIG. 2;

FIG. 6 is a side cross sectional view of the display device taken along line B-B of FIG. 2;

FIG. 7 is a side cross sectional view of the display device taken along line A-A of FIG. 2;

FIG. 8 is an enlarged view of section G-G of FIG. 5;

FIG. 9 is an enlarged view of section H-H of FIG. 6;

FIG. 10 is a side view of a personal watercraft with the display device in accordance with the invention; and

FIG. 11 is a top view of the personal watercraft of FIG. 10.

### DETAILED DESCRIPTION OF PREFERRED EMBODIMENTS

This invention is described with reference to a display device for use on a vehicle. The display device according to this invention can be used on any type of vehicle, including but not limited to personal watercraft, sport boats, all terrain vehicles, snowmobiles, motorcycles and automobiles. It is also contemplated that the display device according to this invention can be used on any type of article of manufacture that utilizes displays, such as machinery and stationary devices.

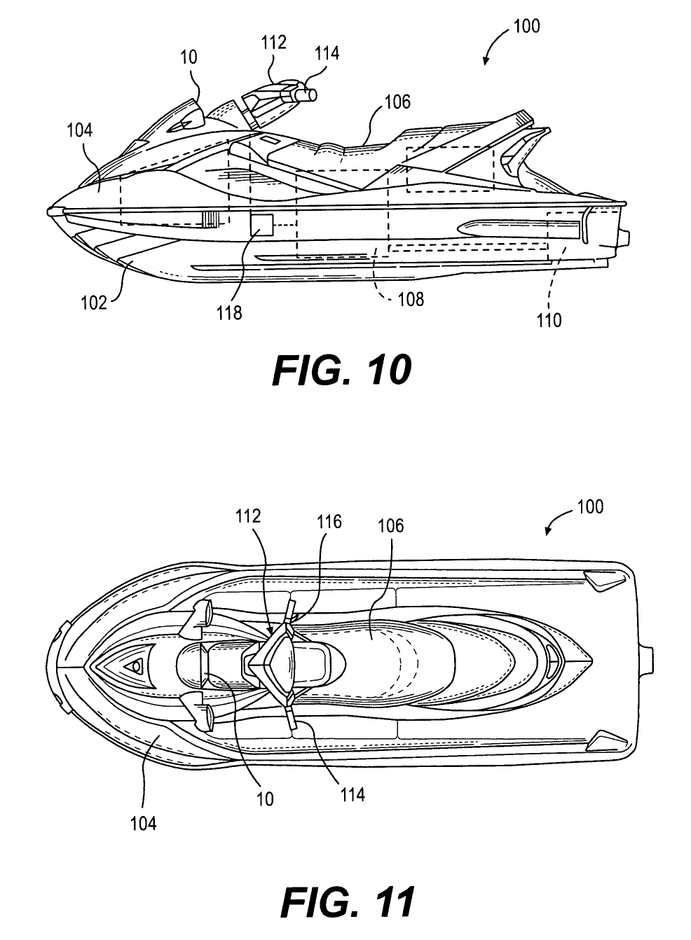

According to one preferred embodiment of the invention, the display device is implemented on a personal watercraft. An example of a suitable personal watercraft 100 is shown in FIGS. 10 and 11 with display device 10. In general, the personal watercraft 100 has a hull 102 that buoyantly supports a deck 104 with a seat 106. An engine 108 mounted within the hull 102 is connected to a jet propulsion system 110 that generates thrust to propel the watercraft 100 through a body of water. A steering and control assembly 112 is disposed in front of the seat 106 and includes handle bars 114 and throttle control 116. In front of the steering and control assembly 112, the display device 10 is mounted to the deck 104 where it can be easily viewed by the watercraft operator. The display device 10 is preferably connected to the electronic control unit (ECU) 118 of the watercraft 100.

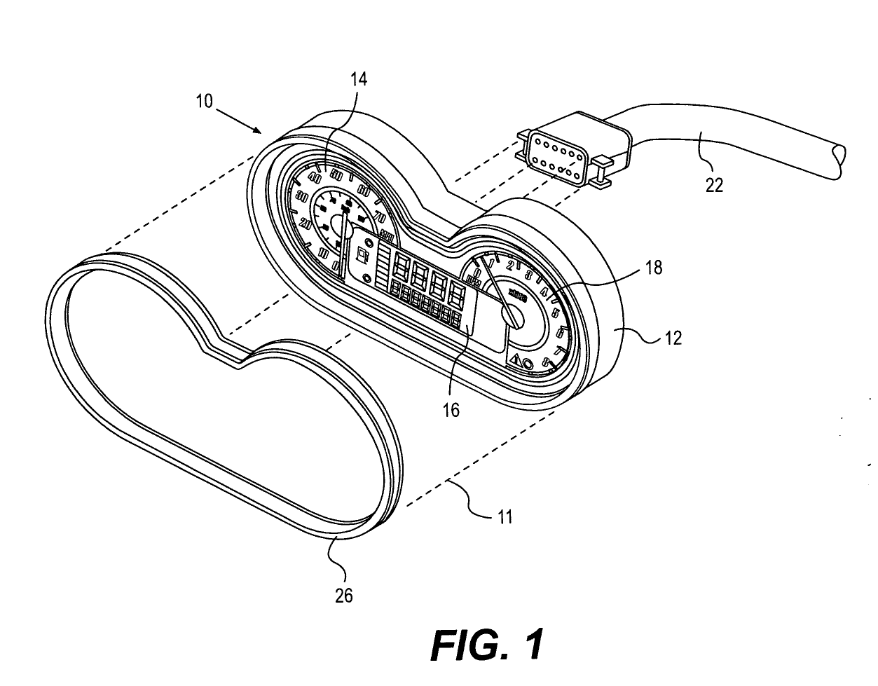

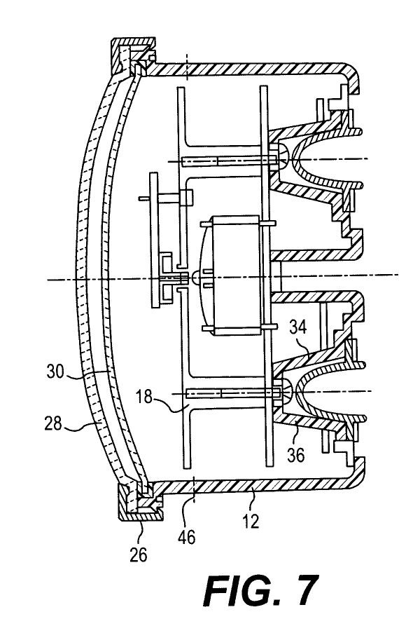

The display device 10 is shown in detail in FIGS. 1-9. The display device 10 is preferably in the form of a display cluster in which several indicators are supported as a unit. The display device 10 includes a cluster casing 12 that houses a plurality of display units, in this case gauges 14, 16, and 18, which are described in detail below. The cluster casing 12 can be formed of any rigid, preferably water resistant material, such as metal or plastic. Preferably, the casing 12 is made of acrilonitrile-butadiene-styrene (ABS). The shape of the cluster casing 12 can be modified depending on the types, number, and sizes of the gauges retained therein. In this embodiment, the cluster casing 12 is shaped in a generally “B” shape to accommodate a pair of analog dial gauges 14 and 18 and a rectangular liquid crystal display 16. Any dimensions represented in the drawings are shown as exemplary design possibilities and are not intended to be limiting.

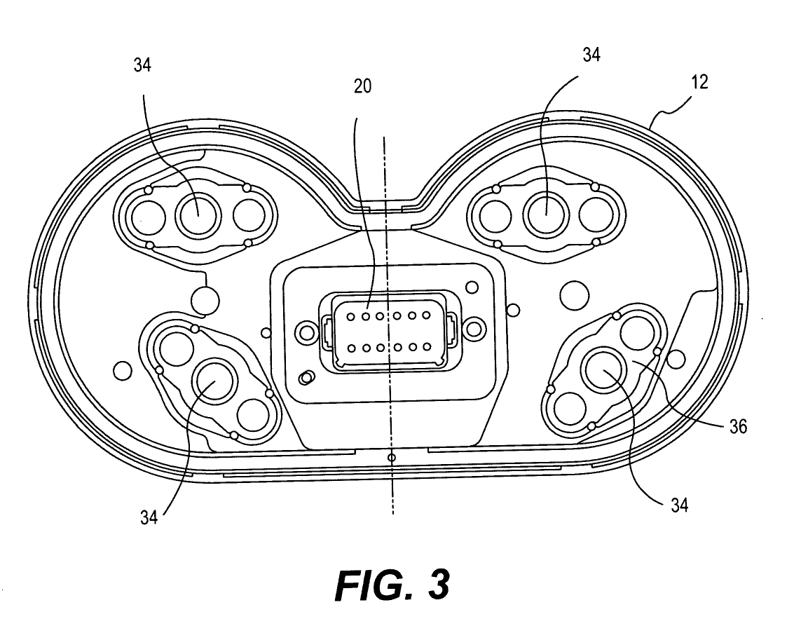

A connection port 20, seen in FIGS. 3-6, is provided on the back of the cluster casing 12 to provide electrical connection from various sensors and controllers carried on the vehicle, in this case the watercraft 10, to the gauges 14, 16, and 18. Any type of connection port 20 can be provided that provides a signal communication path. A gauge harness 22 mounted on the watercraft 10 connects to the connection port 20 as represented by FIG. 1. Preferably, the gauge harness 22 is a conventional port connector that is press fit in place and secured through screws, clamps, or friction fit. The gauge harness 22 can extend from the electronic control unit (ECU) 118 of the vehicle 100, shown schematically in FIG. 10. Any known type of control system can be used, especially a microprocessor.

The cluster casing 12 is supported by the vehicle by any known support mechanism. Preferably, the watercraft 100 has an opening in the deck 104, as seen in FIG. 11, into which the cluster casing 12 fits. For assembly, the gauge harness 22 can be connected to connection port 20, and the cluster casing 12 can be snap fit into place in the deck 104 of the watercraft 100. Of course, any suitable mount can be used, including a dashboard or retractable monitor.

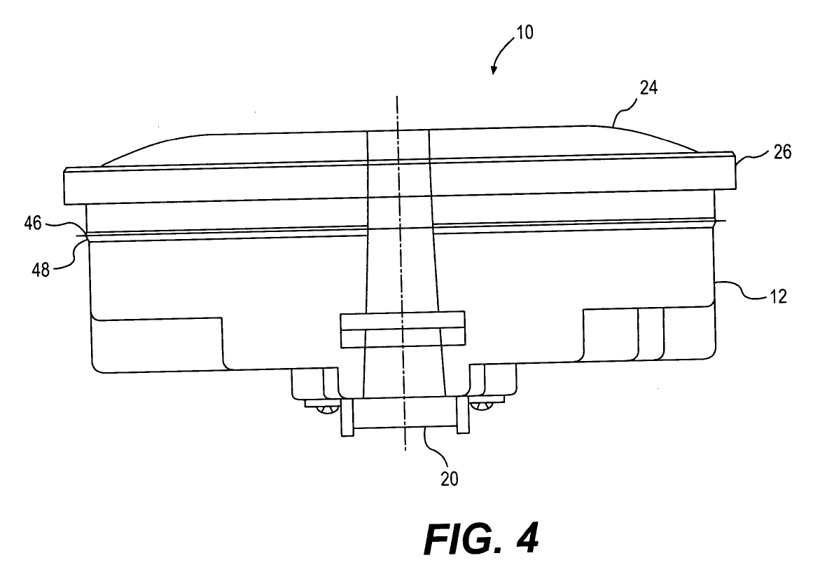

Referring back to FIG. 1, the cluster casing 12 is covered by a window or lens 24 (FIG. 4) that is secured over the gauges 14, 16, and 18 and covered by a frame 26. The window 24 is transparent to allow the gauges retained in the cluster casing 12 to be viewed. The window 24 can be clear or tinted to assist in viewing in direct sunlight. Preferably the window 24 is made of impact resistant plastic, but glass may also be used.

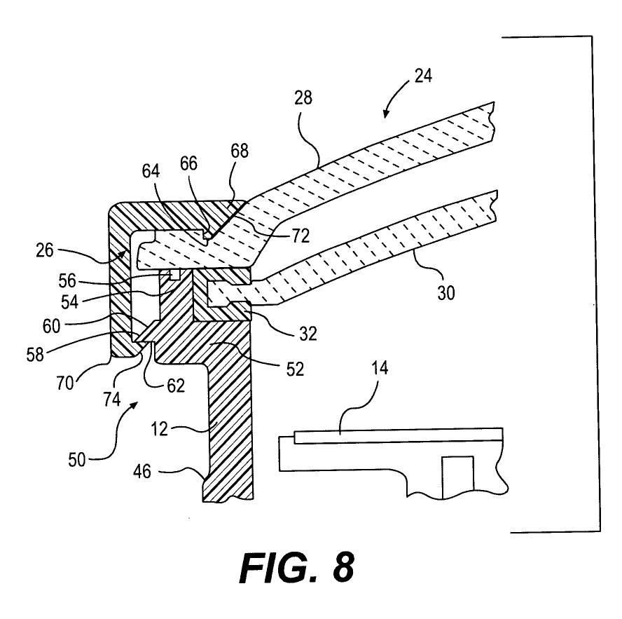

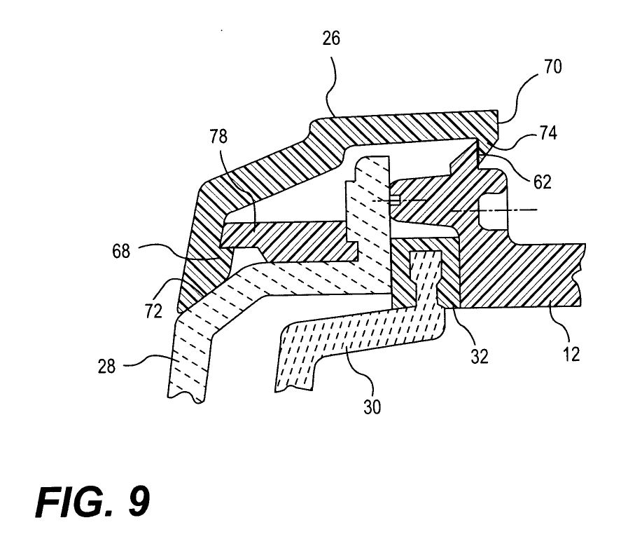

If desired, a double glazed window 24 may be provided, as seen in FIGS. 8 and 9. This provides additional protection to the gauges 14, 16, and 18 retained within the cluster casing 12 and prevents fogging. The outside window 28 is preferably fixed to the cluster housing 12, by bonding for example. The inside window 30 is sandwiched between the outside window 28 and the cluster casing 12. A seal 32 is disposed between the window 30 and the cluster casing 12 to provide a watertight connection and to cushion the window 24 during operation of the vehicle 100. Additional seals can be used at various connection locations if desired. The seal 32 can be made of any conventional sealing material, including a rubberized sealing ring.

The cluster casing 12 has expansion openings 34, seen in FIG. 3, formed in the bottom. The openings 34 have resilient inserts 36, preferably made of rubber. Since the cluster casing 12 is sealed, the pressure can vary within the display device 10 due to temperature fluctuations. The inserts 36 move in response to pressure inside the cluster casing 12 to vary the internal volume. This protects the casing 12 and window 24 from breaking due to temperature and hence internal pressure fluctuations.

The cluster casing 12 with the gauges 14, 16, and 18 and window 24 installed functions as a self contained and sealed unit. By the above sealing arrangement, the display device 10 can be made water resistant, which facilitates use on the watercraft 100. This design is advantageous for other vehicles, as well, particularly other types of watercraft, all terrain vehicles and snowmobiles.

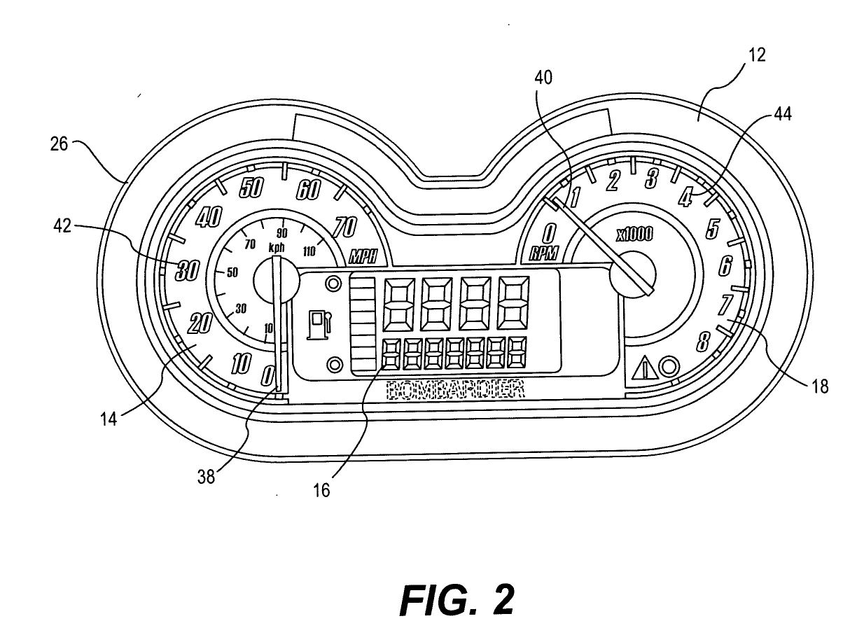

Referring to FIG. 2, the gauges 14, 16, and 18 are shown in detail. Gauge 14 is an analog gauge that displays the measured vehicle speed. Gauge 18 is also an analog gauge that displays the engine revolution per minute (RPM). The gauges 14 and 18 have needles 38 and 40, respectively, that move in response to signals output by the ECU 118 by electrical actuators, as is known. The gauges 14 and 18 have appropriate indicia 42 and 44, respectively, that represent the measured values. The needles 38 and 40 point to the appropriate value shown by the indicia 42 and 44 on the face of the gauges 14 and 18. Gauge 16 is a liquid crystal display (LCD) that displays various sensed conditions, including, for example, time, mileage, gas level, temperature, and operator warnings. The gauge 16 can be configured to operate according to several different modes, if desired.

FIGS. 4-9, refer more specifically to the frame 26 and the connection between the frame 26 and the cluster casing 12. As noted above, the cluster casing 12 with the window 24 installed over the gauges 14, 16, and 18 is a sealed unit. The frame 26 is installed onto the cluster casing 12 to finish the edge connection of the casing 12 and the window 24.

As seen in FIG. 4, the cluster casing 12 has an outer lip 46 that extends around the outer surface of the casing 12. The lip 46 is spaced inwardly of the edge of the casing 12 and can extend entirely around the perimeter or be formed of disparate sections. The lip 46 has a beveled edge 48 that facilitates sliding the cluster casing 12 into a support on the vehicle. This enables the display device 10 to be snap fit into a vehicle support.

Referring to FIGS. 8 and 9, the cluster casing 12 also has an L-shaped flange 50 formed at the edge. The flange 50 extends outward from the outer surface of the casing 12, which forms an inner ledge 52 and a perimeter 54. The perimeter 54 supports the outer window 28. As noted above, the outer window 28 is fixed to the perimeter 54, by bonding for example. A bond 56 between the outer window and the perimeter 54. The inner ledge 52 supports the inner window 30 with the sealing ring 32 disposed around the edge of the inner window 30. By this, the inner window 30 is clamped between the cluster casing 12 and the outer window 28 with the sealing ring 32 disposed between the contacting surfaces. This forms a watertight connection that seals the gauges 14, 15, 18 within the casing 12.

A snap tab 58 is disposed on the outer surface of the flange 50. The snap tab 58 has a beveled edge 60 and a stop surface 62. The snap tab 58 can be formed as an annular protrusion around the outer surface of the flange 50 or as disparate sections.

The outer window 28 is also formed with a groove 64 around its edge that has a stop surface 66. The frame 26, which is slightly flexible, as it is preferably made of plastic or other thin pliable material, snaps onto the outer edge of the casing 12 and the window 24 as follows.

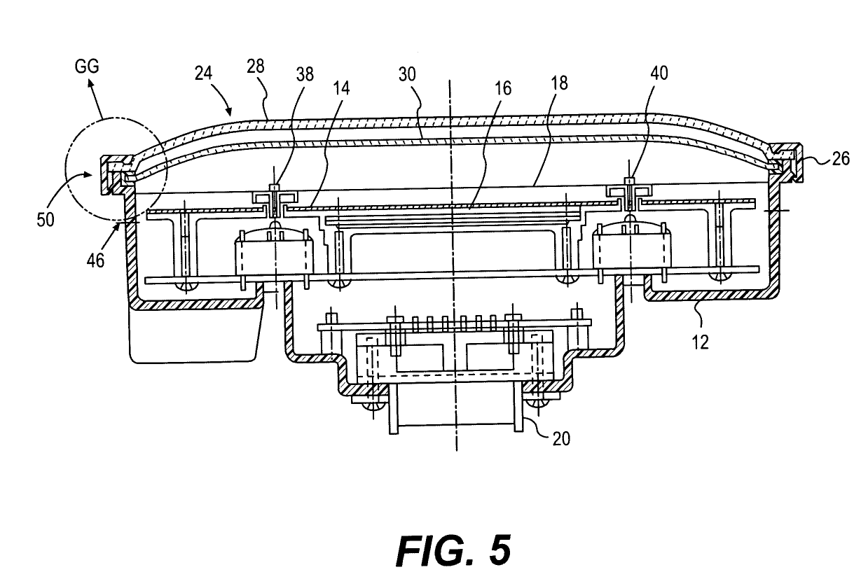

The frame 26 is shaped to conform to the outer edge of the cluster casing 12, as seen in FIG. 1. In cross section, as seen in FIGS. 5-9, the frame 26 has a generally L-shaped cross section. At the end of each leg of the L, a hook 68 and 70 is formed. Each hook 68 and 70 has an outer beveled surface 72 and 74, respectively, to facilitate sliding. Hooks 68 and 70 can be formed as discrete, spaced hooks disposed around the perimeter of the frame 26 or as a hooked edge or a combination thereof. Any number of hooks 68 and 70 can be used. For example, in a preferred embodiment, hook 68 is formed as a hooked edge that extends substantially around the inner perimeter of the frame 26 with spaced breaks, and hook 70 is formed as a plurality of short tabbed hooks that extend around the inner periphery of the frame 26 aligned with the breaks. By this, the frame 26 may be easily removed by flexing the edge to disengage the hooks 70.

As seen clearly in FIG. 8, beveled surface 72 of hook 68 fits into groove 64 and engages stop surface 66. Beveled surface 74 of hook 70 slides over beveled edge 60 of snap tab 58 and engages stop surface 62. To remove the frame 26, hook 70 is flexed outwardly to disengage stop surface 62 to easily remove the frame 26 from the casing 12. Alternatively, the frame 26 can be made to press fit around cluster casing 12.

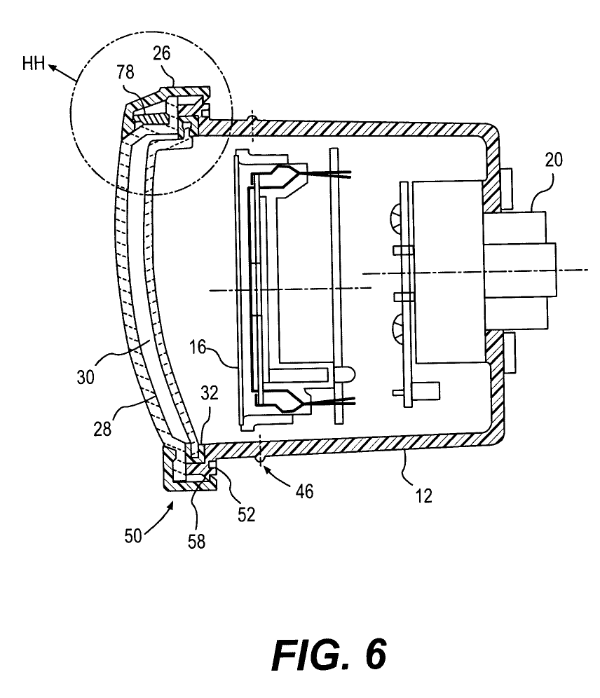

FIG. 9 shows an additional insert 78 that may be provided between the outer window 28 and the frame 26 to accommodate different shapes of the display device 10. For example, as seen in FIG. 1, the casing has a central depression. To accommodate the depression and maintain a flush surface between the edge of the frame 26 and the window 24, as seen in FIG. 6, the insert 78 can be placed at the edge of the window 24 to extend the frame 26 outwardly. Preferably, the insert 78 is bonded or otherwise secured to the window 24. This portion of the frame 26 has a modified L-shaped with an extra extension to better conform to the shape of the window 24. Inserts of this type may be used where desired to accommodate different design configurations of the display device 10.

In a preferred design, the frame 26 is formed as an interchangeable piece that may be formed of a variety of colors and finishes. For example, one frame 26 may be made of black plastic, while another frame 26 may be made of chrome color painted plastic. As the frames 26 are made of lightweight plastic, frames 26 having different aesthetic qualities may be interchanged by the manufacturer, assembler or even the user of the vehicle cheaply and easily. As each cluster casing 12 will have the flange 50 and snap tab 58, the basic design for the cluster casing 12 can remain the same, which is a cost savings.

Of course, other shapes and configurations can be used and remain within the scope of the invention. The particular design parameters can be varied to suit the application of the display device.

While advantageous embodiments have been described herein to illustrate the invention, it will be understood by those of ordinary skill in the art that various changes and modifications can be made to the invention without departing from the scope of the invention as defined in the following claims.

What is claimed is:

1. A display device, comprising:
a casing;
at least one gauge disposed in the casing;
a connector port supported by the casing and connected to the at least one gauge;
a window on the casing over the at least one gauge; and
a frame removably attached to the casing.

2. The display device of claim 1, wherein the frame is formed of flexible plastic.

3. The display device of claim 1, wherein the frame has a generally L-shaped cross-section.

4. The display device of claim 1, wherein the at least one gauge comprises a plurality of gauges arranged as a cluster.

5. The display device of claim 1, wherein the at least one gauge is selected from a group consisting of an analog dial gauge and a liquid crystal display.

6. The display device of claim 1, wherein the window is sealed onto the casing.

7. A vehicle having a display device, comprising:
a vehicle body;
an operator seat carried on the body;
an engine supported by the body configured for driving the vehicle;
an electronic control unit connected to the engine; and
a display device connected to the electronic control unit and positioned within visual proximity to the operator seat, wherein the display device includes at least one gauge that displays a sensed condition of the vehicle, a casing that houses the at least one gauge, a window on the casing over the gauge, and a display frame removably coupled to the casing.

8. The vehicle of claim 7, wherein the at least one gauge includes a plurality of gauges arranged as a cluster and wherein the casing houses the cluster of gauges.

9. The vehicle of claim 7, wherein the at least one gauge is selected from the group consisting of an analog dial gauge and a liquid crystal display.

10. The vehicle of claim 7, wherein the seat is a straddle type seat.

11. The vehicle of claim 7, wherein the vehicle body comprises a hull.

12. The vehicle of claim 7, wherein the display frame is an annular plastic member.

13. The vehicle of claim 7, wherein the display frame has a generally L-shaped cross section with hooks at each edge.

14. The vehicle of claim 12, wherein the window is sealed onto the casing.

15. A frame for use on a display device, comprising an annular member formed of plastic and having a generally L-shaped cross sectional configuration with two legs, wherein each leg removably engages an edge of the display device.
